(19) United States
(12) Patent Application Publication
(10) Pub. No.: US 2009/0104340 A1
(43) Pub. Date: Apr. 23, 2009

(54) NATURAL BEAN-CURD AND ITS PREPARATION METHOD

(76) Inventors: Sung-Yong Hwa, Jinju-City (KR); Kyu-Shik Jeong, Daegu-City (KR); Sun-Hee Do, Daegu-City (KR); Won-Il Jeong, Daegu-City (KR); Da-Hee Jeong, Daegu-City (KR); Gi-Ppeum Lee, Pohang-City (KR); Eun-Mi Cho, Daegu-City (KR)

Correspondence Address: IPLA P.A., 3580 WILSHIRE BLVD., 17TH FLOOR, LOS ANGELES, CA, 90010, US

(21) Appl. No.: 11/573,532

(22) PCT Filed: Aug. 5, 2005
(86) PCT No.: PCT/KR05/02552

§ 371 Date: Nov. 17, 2008

(30) Foreign Application Priority Data
Aug. 10, 2004 (KR) 10-2004-0062957
Aug. 2, 2005 (KR) 10-2005-0070546

(51) Int. Cl. A23L 1/20

(52) U.S. Cl. 426/634

(57) ABSTRACT

The present invention relates to natural and functional bean-curd having good storage stability and comprising various nutrients contained in Japanese apricots and red algae as well as those of soybean, which is—prepared by using fruit vinegar and red algae as natural coagulant. In the present invention, red algae and fruit vinegar employed as coagulant serves day as inorganic salts and as organic acid, respectively, to coagulate bean-curd, so that two coagulation principles work together, and thus it is distinguishable from conventional process for preparing bean-curd. The process according to the present invention comprises the steps of 1) washing and immersing soybean with water; 2) adding water and finely pulverizing the mixture by the use of a mixer to prepare bean paste! 3) heating the bean paste and removing bean-curd dregs to provide soybean milk; 4) introducing natural coagulant thereto and coagulating the soybean milk with stirring to provide uncurdled bean-curd; and 5) pouring the uncurdled bean-curd on a mold on which a hemp cloth is laid and compressing it to provide bean curd.

### TECHNICAL FIELD

The present invention relates to natural and functional bean-curd having good storage stability and comprising various nutrients contained in Japanese apricots and red algae as well as those of soybean, which is prepared by using fruit vinegar and red algae as natural coagulant.

### BACKGROUND ART

Bean-curd was firstly invented by Ryuan, when he was the king of Huai-nan at the age of Han Dynasty in China, about 2000 years ago, and introduced to Korea at the age of Goryeo Dynasty for the first time. Initially, it was only used as food in Buddhist temples, but afterward widely popularized. Having soft texture with high nutritive value and digestion efficiency with low price, bean-curd has been loved as a primary protein supplier for common people.

Bean-curd has been reported to have the activities of lowering blood cholesterol, preventing osteoporosis, enhancing renal function and inhibiting arteriosclerosis. Genistein, the primary isoflavone of soybean has anticancer activity through anti-oxidant activity and even serves as a female hormone.

However, as bean-curd contains not less than 80% of water, the microorganisms being present in soybean is ready to be transferred to bean-curd to lower the preservation, and bean-curd is apt to be polluted during distribution, so that the best-before period is very short. In addition, bean-curd has a disadvantage of low efficiency of calcium in vivo, because calcium sulfate or the like, which is used in the process for preparing bean-curd, has low dissociation level, even though it has higher calcium content as compared to other protein foodstuffs.

Bean-curd is prepared through the steps of washing—immersion—pulverization—filtration—heating—coagulation—molding. Among those steps, coagulation step, depending upon type and amount of the coagulants, gives greatest effect on the structural texture of bean-curd.

The principles of coagulation are divided into two categories: coagulation by means of inorganic salt and that of organic acid. Representative inorganic salts include calcium sulfate (CaSO₄), magnesium chloride (MgCl₂). When the salt is added, Ca²⁺ or Mg²⁺ ion is bonded to carboxylic group (—COOH) of glycine (NH₂CH₂COOH) in the protein being present as colloidal state of the soybean milk, so that H is substituted by Ca and the free H⁺ promotes dehydration between amino group and carboxylic group to form a huge peptide molecule and be precipitated, or —N—and C═O in the protein, that are able to make coordinate bond, exhibit chelate activity by means of Ca²⁺ to be precipitated. Calcium sulfate, having very low solubility, slowly dissolves and reacts, so that it is easily handled and gives high yield. On the other hand, since calcium chloride with high solubility rapidly reacts, it gives low yield. Magnesium chloride gives softer, precipitation and higher yield as compared to calcium chloride.

Representative organic acid is glucono delta lactone (G.D.L.), which is converted to a gluconic acid molecule when dissolved in water, to lower the pH, and when it reaches isoelectric point (pH 4.2˜4.6) it loses solubility and is precipitated. In view of yield or quality, coagulation by the use of organic acid is far superior to that by inorganic salts, but the former has a disadvantage of sour taste remaining in bean-curd.

### DISCLOSURE

### Technical Problem

The present invention intends to provide natural and functional bean-curd having good storage stability as well as rich nutrients such as vitamins and minerals, which is prepared by using fruit vinegar (organic acid) and red algae (inorganic salt) as natural coagulant.

Another object of the present invention is to provide bean-curd having less sour taste and being rich in vitamins, calcium and minerals, by using the mixture of fruit vinegar and red algae as natural coagulant.

Still another object of the invention is to provide bean-curd having excellent texture and flavor with less characteristic taste of soybean, by using the mixture of fruit vinegar and red algae as natural coagulant.

### Technical Solution

The present invention provides natural and functional bean-curd having good storage stability with various nutrients from Japanese apricots and red algae as well as those of soybean, which is prepared by using fruit vinegar and red algae as natural coagulant.

In the present invention, red algae and fruit vinegar employed as coagulant serve as inorganic salts and as organic acid, respectively, to coagulate bean-curd. That is, in the present invention, two coagulation principles mentioned above work together, so that it is distinguishable from conventional process for preparing bean-curd.

In the present invention, the red algae employed may be any one or more of those selected from the group consisting of Porphyratenera, Gelidium amansii, Gracilaria verrucosa, Nemalion vermiculare, Bangia fusco-purpurea, Grateloupia filicina, Gigartina tenella, Ceramium Kondoi, floridean starch, Phymatolithon calcareum, Lithotahmnion corallioides, but not restricted thereto.

For the fruit vinegar, any edible fruit may be unlimitedly employed, but vinegar prepared from any one or more of those selected from the group consisting of Japanese apricot, grape, apple and persimmon is more preferable.

Japanese apricots are alkaline food containing a large amount of organic acids such as citric acid and malic acid, various vitamins and alkaline elements such as Ca and K. From ancient times, smoked dry Japanese apricots are effective in detoxification and extermination of worms. In a number of literature regarding oriental medicines including Class and Order of Medicinal Herbs, it has been written that Japanese apricots are effective on chronic asthma, bloody flux, melaena, hematuria, stomachache, chest pain, emesis, menstrual irregularity, paralysis, and the like. Recently, a variety of activities of Japanese apricots are scientifically testified and their anti-oxidant, anti-cancer, antibacterial and acopic activity, and activity of promoting alcohol metabolism, and the like have been known.

In addition, 100% botanical natural calcium contained in red algae, which has porous structure, can be applied to a variety of food, and exhibits higher bio-availability as compared to calcium carbonate, but continually lowers the level of PTH to give superior pharmacokinetic reaction.

However, if organic acid of fruit vinegar alone is used in preparing bean-curd, the content of physiologically active components such as vitamins is high, but involving a problem—that a consumer may misunderstand that the bean-curd got bad because of its strong sour taste. If bean-curd is prepared by using inorganic salts of seaweeds alone, storage stability is lowered and physiologically active components such as vitamins are not contained in the bean-curd.

Thus, the present invention provides novel bean-curd which has less sour taste but rich in vitamins, calcium and minerals and has excellent flavor, structural texture and homogeneity, so that it can be stored for a long time with good storage stability, and a process for preparing the same.

The process for preparing natural and functional bean-curd according to the present invention comprises the steps of:
1) washing and immersing soybean with water;
2) adding water and finely pulverizing the mixture by the use of a mixer to prepare bean paste;
3) heating the bean paste at a temperature from 95° C. to 100° C. for from 8 to 12 minutes, and removing bean-curd dregs to provide soybean milk;
4) introducing from 1 to 2% (v/v, based on total volume of the soybean milk) of natural coagulant, which was prepared by introducing from 400 to 500 g of mixed powder of red algae to 20 L of fruit vinegar and heating in a bath at a temperature from 100 to 130° C. for from 20 to 40 minutes, thereto at 80° C. and coagulating the soybean milk to provide uncurdled bean-curd; and
5) pouring the uncurdled bean-curd on a mold on which a hemp cloth is laid and compressing it to provide bean curd.

Now, the process is described in more detail.

In the process described above, soybean is washed with clean water and immersed therein at room temperature (25° C.), so that soybean may swell up enough to facilitate to be pulverized, during an appropriate period. It is preferable to immerse soybean in water for about 12 hours. If soybean is immersed for a excessively long time, cores of beans are destroyed to promote decomposition and to lower the yield and viscosity, causing problems of storage.

Then, the beans sufficiently swollen are pulverized by the use of a mixer, to provide bean paste. It is preferable to finely pulverize the beans by adding water corresponding to 10 times of soybeans. The bean paste thus obtained is heated at a temperature from 95 to 100° C. for from 8 to 12 minutes, and filtered through a filtering cloth under reduced pressure to remove bean-curd dregs and to provide soybean milk that is ready for extracting protein components and solid substances.

In order to coagulate the soybean milk, from 1 to 2% (v/v) of coagulant prepared by using fruit vinegar and red algae is introduced thereto and the mixture is coagulated with stirring, while the temperature is maintained constant at 80° C.

It is preferable to use the coagulant having the content ratio of from 400 to 600 g, preferably 500 g of red algae powder to 20 L of fruit vinegar. If the amount of red algae is less than 400 g, sour taste of the coagulated bean-curd becomes strong, and lacks calcium content. If the amount is more than 600 g, the coagulation of bean-curd is retarded, and resilience and storage stability of bean-curd are reduced.

It is preferable to prepare the coagulant by adding red algae powder to fruit vinegar and heating in a bath at a temperature from 100 to 130° for from 20 to 40 minutes. As the red algae, any one or more of those selected from the group consisting of Porphyratenera, Gelidium amansii, Gracilaria verrucosa, Nemalion vermiculare, Bangia fusco-purpurea, Grateloupia filicina, Gigartina tenella, Ceramium Kondoi, floridean starch, Phymatolithon calcareum and Lithotahmnion corallioides may be used, preferably a mixture consisting of equal amounts of those red algae being employed.

If the temperature of heating the coagulant in a bath is lower than 100° C. or higher than 130° C., the coagulation time is increased and maintenance of the shape of bean-curd is inferior, so that the coagulant cannot sufficiently serve its role, and it is thus difficult to commercialize the bean-curd finally produced because of bad maintenance of shape and texture.

Then, the coagulated uncurdled bean-curd is contained in a mold on which a hemp cloth is laid and compressing it under 20 g/cm² of pressure for 60 minutes, to provide bean curd. It is preferable that bean curd thus prepared is cooled by water flux for 10 minutes and refrigerated as being immersed in 3-fold by weight of sterilized water.

### BRIEF DESCRIPTION OF DRAWINGS

FIG. 1 demonstrates photographs showing the change of conventional bean-curd and bean-curd prepared according to the invention by the lapse of time.

### MODE FOR INVENTION

Now the present invention is described in more detail by means of following Examples. The described embodiments are to be considered in all respects only as illustrative and not restrictive.

### EXAMPLES

### Preparation Example

### Preparation of Natural Coagulant

With 20 L of commercially available Japanese apricot vinegar, 500 g of red algae powder was mixed, and the mixture was heated in a bath at 100° C. for 30 minutes.

### Preparation Example 2

### Preparation of Coagulant by Using Red Algae

With 20 L of water, 500 g of red algae powder was mixed, and the mixture was heated in a bath at 100° C. for 30 minutes.

### Example 1

### Preparation of Natural and Functional Bean-Curd

Soybeans produced from China (3.3 kg, sorted) were washed with tap water, and swollen by immersing them in water at 25° C. for 12 hours. After adding distilled water corresponding 10-fold amount of soybeans as the raw material, the mixture was finely pulverized by using a mixer to provide bean paste. After heating at 100° C. for 10 minutes, the bean paste was filtered through a filtering cloth to remove the bean curd dregs and to obtain soybean milk. While maintaining the temperature of soybean milk constant at 80° C., the coagulant prepared according to Preparation Example 1 was introduced in an amount of 1.3% (v/v) with stirring, in order to carry out coagulation. The uncurdled bean-curd produced from soybean milk was contained in a mold (15 cm×15 cm×8 cm) on which a hemp cloth is laid, and compressed under 20 g/cm² of pressure for 60 minutes. After cooling the molded bean-curd in water flux for 10 minutes, the bean-curd is refrigerated (5° C.) as being immersed in 3-fold by weight of sterilized water.

### Example 2

Bean-curd was prepared as described in Example 1, but coagulation was carried out by introducing 3% (v/v) of coagulant prepared according to Preparation Example 1.

### Comparative Example 1

### Preparation of Conventional Bean-Curd

Bean-curd was prepared as described in Example 1, but 0.4% (v/v, based on soybean milk) amount of 10% (v/v) aqueous calcium chloride solution was added as coagulant.

### Comparative Example 2

### Preparation of Bean-Curd by Using Japanese Apricot Vinegar as Coagulant

Bean-curd was prepared as described in Example 1, but Japanese apricot vinegar was used as coagulant.

### Comparative Example 3

### Preparation of Bean-Curd by Using Red Algae as Coagulant

Bean-curd was prepared as described in Example 1, but the coagulant prepared according to Preparation Example 2 was used as coagulant.

### Experimental Example 1

### Componential Analysis of Bean-Curd

Componential analysis of bean-curds prepared by Example 1 and Comparative Example 1 was performed by Dongjin Analytic Technical Research Center, one of the test institute in the field of food sanitation by a request.

TABLE 1
Results of componential analysis of bean-curd

| Component | Comparative | | |
|---|---|---|---|
| tested | Example 1 | Example 1 | Unit |
| Phosphorus | Not detected | Not detected | mg/100 g |
| Iron | 2.693 | 2.097 | mg/100 g |
| Calcium | 30.810 | 38.600 | mg/100 g |
| Zinc | 1.705 | 2.383 | mg/100 g |
| Magnesium | 51.350 | 52.250 | mg/100 g |
| Sodium | 2.663 | 1.942 | mg/100 g |
| Potassium | 69.720 | 81.300 | mg/100 g |
| Copper | 0.176 | 0.177 | mg/100 g |
| Manganese | 1.242 | 0.982 | mg/100 g |
| Iodine | Not detected | Not detected | mg/100 g |
| Crude protein | 12.721 | 11.065 | % |
| Vitamin C | Not detected | 11.555 | mg/100 g |
| Niacinamid | 0.140 | 0.330 | mg/100 g |

As can be seen from Table 1, the bean-curd prepared according to Example 1 has higher contents of calcium, potassium and vitamin C as compared to that of Comparative Example 1. In respect of calcium content, though much amount is present in the bean-curd according to Comparative Example 1, it has disadvantage of low bio-availability owing to very low absorbing efficiency as compared to that contained in red algae. It is considered that high potassium content is due to the content of alkaline elements such as Ca and K in Japanese apricots. Such alkaline food may prevent humoral acidification caused by increasing consumption of acidic food. It is found that the bean-curd of Example 1 contained large amount of vitamin C that was not detected in that of Comparative Example at all.

### Experimental Example 2

### Sensory Test of Bean-Curd

Ten (10) testers who tasted the bean-curd were made to evaluate the resilience, rigidity, texture, flavor, characteristic bean taste, astringent taste and sour taste according to the 5-level score measurement. Texture and flavor were evaluated as very good (score 5), good (score 4), moderate (score 3), bad (score 2) and very bad (score 1), while the resilience, rigidity, characteristic bean taste, astringent taste and sour taste were evaluated as very strong (score 5), strong (score 4), moderate (score 3), weak (score 2) and very weak (score 1).

TABLE 2
Results from sensory test of bean-curd

| | | | | | Characteristic | Astringent | Sour |
|---|---|---|---|---|---|---|---|
| | Resilience | Rigidity | Texture | Flavor | bean taste | taste | taste |
| Ex. 1 | 3.1 ± 0.28 | 2.9 ± 0.23 | 3.9 ± 0.23 | 3.6 ± 0.27 | 2.6 ± 0.16 | 3 ± 0.21 | 3.1 ± 0.28 |
| Ex. 2 | 2.5 ± 0.24 | 2.5 ± 0.23 | 3.5 ± 0.24 | 3.6 ± 0.01 | 2.6 ± 1.10 | 4 ± 0.03 | 3.3 ± 0.25 |
| Comp. | 3.4 ± 0.27 | 3.6 ± 0.16 | 3.1 ± 0.23 | 3 ± 0.21 | 3.2 ± 0.25 | 2.8 ± 0.29 | 2.4 ± 0.22 |
| Ex. 1 | | | | | | | |
| Comp. | 3.7 ± 0.33 | 3.8 ± 0.18 | 3.5 ± 0.21 | 2 ± 0.37 | 2.5 ± 0.25 | 2.8 ± 0.31 | 4.0 ± 0.12 |
| Ex. 2 | | | | | | | |
| Comp. | 2.7 ± 0.25 | 2.2 ± 0.15 | 3.2 ± 0.17 | 2.5 ± 0.28 | 2.4 ± 0.27 | 3.4 ± 0.33 | 2.0 ± 0.37 |
| Ex. 3 | | | | | | | |

As can be seen from Table 2, the bean-curd of Example 1 which was prepared by using a mixture of Japanese apricot vinegar and seaweeds as coagulant was found to have excellent texture and flavor, less sour taste when compared to the bean-curd prepared by using Japanese apricot vinegar as coagulant, and better resilience and less characteristic bean taste as compared to the bean-curd prepared by using seaweeds as coagulant.

### Experimental Example 3

### Test of Storage Property of Bean-Curd

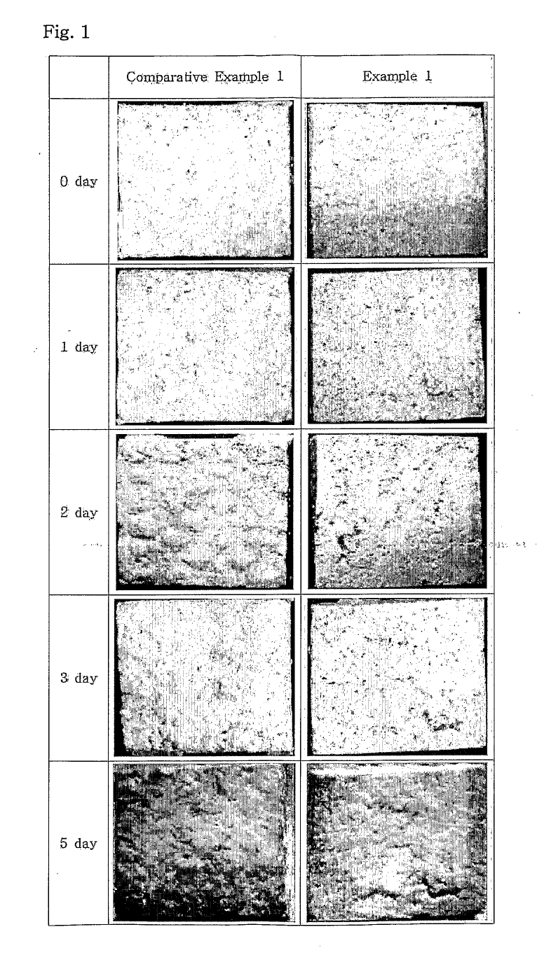

The molded bean-curd was cut in a size of 12 cm×12 cm×2 cm and stored at ambient temperature for 5 days, and change of the appearance of the bean-curd prepared according to Comparative Example 1 and that of Example 1 were compared to each other by the lapse of time. The results are shown in FIG. 1.

As can be seen from FIG. 1, on the 0^{th} day immediately after the preparation, there was very little apparent color difference between the bean-curd of Comparative Example 1 and that of Example 1, but as time goes by, the bean-curd of Comparative Example 1 was rapidly converted to yellow as compared to that of Example 1. It is believed that this is because the storage property was enhanced in the bean-curd prepared according to Example 1 due to the anti-bacterial property of Japanese apricots.

### INDUSTRIAL APPLICABILITY

The bean-curd prepared according to the present invention has the effect of overcoming the disadvantages of conventional bean-curd such as poor storage property and low bio-availability of calcium.

Further, the present invention provides natural and functional bean-curd, which can neutralize acidity of soybean protein by virtue of alkaline property of fruit, and have physiological activity of vitamin C and high calcium content by virtue of red algae, thereby being beneficial to human health.

In addition, the present invention can provide bean-curd with excellent texture and flavor, but less characteristic bean taste as compared to conventional bean-curd, by employing natural coagulant.

Simple modifications and variations of the present invention fall under the scope of the invention, and the specific scope of the invention is clarified by the claims appended.

What is claimed is:

1. A process for preparing natural and functional bean-curd, which comprises the steps of:
1) washing and immersing soybean with water;
2) adding water and finely pulverizing the mixture by the use of a mixer to prepare bean paste;
3) heating the bean paste and removing bean-curd dregs to provide soybean milk;
4) introducing natural coagulant, which was prepared by mixing any one or more of those selected from the group consisting of Porphyratenera, Gelidium amansii, Gracilaria verrucosa, Nemalion vermiculare, Bangia fusco-purpurea, Grateloupia filicina, Gigartina tenella, Ceramium Kondoi, floridean starch, Phymatolithon calcareum and Lithotahmnion corallioides with fruit vinegar and heating the mixture in a bath at a temperature from 100 to 130° C. for from 20 to 40 minutes, thereto at 80° C. with stirring and coagulating the soybean milk to provide uncurdled bean-curd; and
5) pouring the uncurdled bean-curd on a mold on which a hemp cloth is laid and compressing it to provide bean curd.

2. A process for preparing natural and functional bean-curd according to claim 1, wherein the natural coagulant is prepared by adding from 400 to 600 g of mixed powder of red algae to 20 L of fruit vinegar.

3. A process for preparing natural and functional bean-curd according to claim 1, wherein the natural coagulant is introduced in an amount of from 1 to 3% (v/v) while maintaining the temperature of the soybean milk at 80° C.

4. A process preparing natural and functional bean-curd according to claim 1, wherein the mixed powder of red algae employed is prepared by mixing equal amounts of Porphyratenera, Gelidium amansii, Gracilaria verrucosa, Nemalion vermiculare, Bangia fusco-purpurea, Grateloupia filicina, Gigartina tenella, Ceramium Kondoi, floridean starch, Phymatolithon calcareum and Lithotahmnion corallioides.

5. Natural and functional bean-curd prepared according to any one of claims 1 to 4.
